(19) United States
(12) Patent Application Publication
(10) Pub. No.: US 2025/0220686 A1
(43) Pub. Date: Jul. 3, 2025

(54) MESSAGING FOR INTER-USER EQUIPMENT COORDINATION

(71) Applicant: Lenovo (Singapore) Pte. Limited, Singapore (SG)

(72) Inventors: Karthikeyan Ganesan, Kronberg Im Taunus (DE); Joachim Löhr, Wiesbaden (DE); Alexander Golitschek Edler von Elbwart, Darmstadt (DE); Ravi Kuchibhotla, Chicago, IL (US)

(73) Assignee: Lenovo (Singapore) Pte. Limited, Singapore (SG)

(21) Appl. No.: 18/848,108

(22) PCT Filed: Mar. 15, 2023
(86) PCT No.: PCT/IB2023/052529

§ 371 Date: Sep. 17, 2024

Related U.S. Application Data
(60) Provisional application No. 63/321,441, filed on Mar. 18, 2022.

(51) Int. Cl. H04W 72/25; H04L 1/1812; H04L 1/1829; H04L 5/00

(52) U.S. Cl. CPC H04W 72/25; H04L 1/1854; H04L 5/0055; H04L 1/1812

(57) ABSTRACT

Implementations for messaging for inter-user equipment (UE) coordination are described, such as related to providing ways for handling scenarios for inter-UE coordination where portions of requests for inter-UE coordination information and/or replies to requests for inter-UE coordination information are not successfully received.

### RELATED APPLICATION

This application claims priority to U.S. Patent Application Ser. No. 63/321,441 filed 18 Mar. 2022 and entitled “MESSAGING FOR INTER-USER EQUIPMENT COORDINATION,” the disclosure of which is incorporated by reference herein in its entirety.

### TECHNICAL FIELD

The present disclosure relates to wireless communications, and more specifically to inter-device communication.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Wireless communications not only involve network-based communications but include direct UE-to-UE communications, e.g., via sidelink connectivity between UEs. For instance, UEs can negotiate sidelink connections with one another for exchanging data directly between the UEs.

### SUMMARY

The present disclosure relates to methods, apparatuses, and systems that support messaging for inter-UE coordination. For instance, the described techniques provide ways for handling scenarios for inter-UE coordination where a request (e.g., an explicit request) for inter-UE coordination information is transmitted via a medium access control-control element (MAC-CE) and sidelink control information (SCI) and portions of the request in the MAC-CE are unable to be decoded. Further, the described techniques provide ways for handling scenarios for inter-UE coordination where inter-UE coordination information is transmitted via a MAC-CE and SCI and portions of the inter-UE coordination information in the MAC-CE are unable to be decoded. Implementations also provide for priority-based handling of requests for inter-UE coordination information. By utilizing the described techniques, errors that occur as part of negotiating UE-to-UE communication (e.g., sidelink communications) can be mitigated.

Some implementations of the method and apparatuses described herein may include wireless communication at a device (e.g., a UE), and the device receives, from a second UE, one or more sidelink messages including a request for inter-coordination between the first UE and the second UE, the one or more sidelink messages including one or both of a sidelink control message or a sidelink data message, the sidelink control message including SCI and the sidelink data message including a MAC-CE; processes the request based on a determination of whether the sidelink data message can be decoded; and transmits, to the second UE, a hybrid automatic repeat request (HARQ) feedback message indicating a status of the decoding of the sidelink data message.

In some implementations of the method and apparatuses described herein, the device (e.g., UE) causes the first UE to transmit inter-UE coordination information to the second UE based on a priority indication for the inter-UE coordination information; determines not to transmit inter-UE coordination information based on a determination that the sidelink data message cannot be decoded; and transmits a negative acknowledgement message to the second UE, the negative acknowledgement message including a request for retransmission, to the first UE, of the sidelink data message multiplexed with other data; determines that the sidelink data message cannot be decoded; transmits, based on the request, inter-UE coordination information to the second UE; and transmits a negative acknowledgement message to the second UE, the negative acknowledgement message including a request for retransmission, to the first UE, of the sidelink data message multiplexed with other data; determines that the sidelink data message cannot be decoded; transmits, based on successfully receiving the sidelink control message with the request, inter-UE coordination information to the second UE; and transmits an acknowledgement message to the second UE, the acknowledgement message acknowledging receipt and processing of the request.

In some implementations of the method and apparatuses described herein, the device (e.g., UE) determines not to transmit inter-UE coordination information based on the determination that the sidelink data message cannot be decoded; and transmits a negative acknowledgement message to the second UE, the negative acknowledgement message including a request for retransmission, to the first UE, of the sidelink data message not multiplexed with other data; generates an inter-UE coordination message that includes inter-UE coordination information; and determines whether to transmit the inter-UE coordination message based on whether the sidelink data message is successfully decoded; initiates a timer based on receiving the request; and determines whether to transmit the inter-UE coordination message based on whether the sidelink data message is successfully decoded prior to expiry of the timer; initiates a timer based on receiving the request; determines that the sidelink data message is successfully decoded after expiry of the timer; and generates the inter-UE coordination message based on a priority value for the request being above a threshold priority value; causes the first UE to ignore the request based on a determination that information in the sidelink control message does not match information in the sidelink data message; determines that a resource set type field of the request is indicated as a preferred resource set; and generates and transmit inter-UE coordination information to the second UE irrespective of the status of the decoding of the sidelink data message.

Some implementations of the method and apparatuses described herein may include wireless communication at a device (e.g., a UE), and the device receives, from a second UE, one or more sidelink messages including a response to a request from the first UE to the second UE for inter-coordination between the first UE and the second UE, the one or more sidelink messages including one or both of a sidelink control message or a sidelink data message, the sidelink control message including SCI and the sidelink data message including a MAC-CE; processes the response based on a determination of whether the sidelink data message can be decoded; and transmits, to the second UE, a HARQ feedback message indicating a status of the decoding of the sidelink data message.

In some implementations of the method and apparatuses described herein, the device (e.g., UE) causes the first UE to transmit the request from the first UE to the second UE for inter-coordination based on a priority indication for the request; determines not to process inter-UE coordination information received as part of the response based on a determination that the sidelink data message cannot be decoded; and transmits a negative acknowledgement message to the second UE, the negative acknowledgement message including a request for retransmission, to the first UE, of the sidelink data message multiplexed with other data; determines that the sidelink data message cannot be decoded; processes, based on successfully receiving the sidelink control message with the response, inter-UE coordination information received as part of the response; and transmits an acknowledgement message to the second UE, the acknowledgement message requesting retransmission, to the first UE, of the sidelink data message multiplexed with other data; determines that the sidelink data message cannot be decoded; processes, based on successfully receiving the sidelink control message with the response, inter-UE coordination information received as part of the response; and transmits an acknowledgement message to the second UE, the acknowledgement message acknowledging receipt and processing of the inter-UE coordination information.

In some implementations of the method and apparatuses described herein, the device (e.g., UE) determines that the sidelink data message cannot be decoded; processes, based on successfully receiving the sidelink control message with the response, inter-UE coordination information received as part of the response; and transmits a negative acknowledgement message to the second UE, the negative acknowledgement message including a request for retransmission, to the first UE, of the sidelink data message not multiplexed with other data; processes, based on successfully receiving the sidelink control message with the response, inter-UE coordination information received as part of the response; performs, based on the inter-UE coordination information, one or more of resource selection, resource reselection, or resource exclusion; and determines, based on whether the sidelink data message is successfully decoded, whether to transmit an indication of a preferred resource set to a higher layer of the first UE; causes the first UE to ignore inter-UE coordination information received as part of the response based on a determination that inter-UE coordination information included as part of the sidelink control message does not match inter-UE coordination information included as part of the sidelink data message; determines that a resource set type field of the response is indicated as a non-preferred resource set; and processes inter-UE coordination information included in the response irrespective of the status of the decoding of the sidelink data message to cause the non-preferred resource set to be excluded from resource selection.

Some implementations of the method and apparatuses described herein may include wireless communication at a device (e.g., a UE), and the device receives, from a second UE, one or more sidelink messages including a request for inter-UE coordination between the first UE and the second UE, the one or more sidelink messages including one or both of a sidelink control message or a sidelink data message, the sidelink control message including SCI and the sidelink data message including a MAC-CE; processes the request based on a determination of whether the sidelink data message can be decoded; generates inter-UE coordination information based at least in part on the processed request; and prioritizes transmission of the inter-UE coordination information based on a priority indication for the inter-UE coordination information.

In some implementations of the method and apparatuses described herein, the device (e.g., UE), where the priority indication is based on one or more of a priority value indicated in the request for inter-UE coordination, or a priority value configured in a resource pool used to generate the inter-UE coordination information; causes the first UE to prioritize transmission of inter-UE coordination information in response to the request for inter-UE coordination over transmission of inter-UE coordination information in response to a condition-based trigger for inter-UE coordination; where the request for inter-UE coordination includes a request for a non-preferred resource set, and causes the first UE to prioritize transmission of inter-UE coordination information in response to the request for the non-preferred resource set over transmission of inter-UE coordination information in response to a condition-based trigger for inter-UE coordination; where the request for inter-UE coordination includes a request for a preferred resource set, and causes the first UE to prioritize transmission of inter-UE coordination information in response to a condition-based trigger for a non-preferred resource set over the request for the preferred resource set; where prioritizing transmission of the inter-UE coordination information based on the priority indication comprises comparing a priority of transmitting in a slot a request to a third UE for inter-UE coordination to a priority of transmission in the slot of the inter-UE coordination information to the second UE; where prioritizing transmission of the inter-UE coordination information based on the priority indication comprises comparing a priority of transmitting in a slot a request to a third UE for inter-UE coordination to a priority of receiving in the slot inter-UE coordination information from the second UE.

### BRIEF DESCRIPTION OF THE DRAWINGS

Various aspects of the present disclosure for messaging for inter-UE coordination are described with reference to the following Figures. The same numbers may be used throughout to reference like features and components shown in the Figures.

FIG. 1 illustrates an example of a wireless communications system that supports messaging for inter-UE coordination in accordance with aspects of the present disclosure.

FIG. 2 illustrates an example of a block diagram of a device that supports messaging for inter-UE coordination in accordance with aspects of the present disclosure.

FIGS. 3-19 illustrate flowcharts of methods that support messaging for inter-UE coordination in accordance with aspects of the present disclosure.

### DETAILED DESCRIPTION

Implementations of messaging for inter-UE coordination are described, such as related to providing ways for handling scenarios for inter-UE coordination where a request (e.g., an explicit request) for inter-UE coordination information is transmitted via a MAC-CE and SCI and portions of the request in the MAC-CE are unable to be decoded. Further, the described techniques provide ways for handling scenarios for inter-UE coordination where inter-UE coordination information is transmitted via a MAC-CE and SCI and portions of the inter-UE coordination information in the MAC-CE are unable to be decoded. Implementations also provide for priority-based handling of requests for inter-UE coordination information. By utilizing the described techniques, errors that occur as part of negotiating UE-to-UE communication (e.g., sidelink communications) can be mitigated.

Different coordination schemes can be provided for inter-UE coordination as part of UE-to-UE wireless communication. For instance, in some scenarios a first UE (e.g. UE-A) receives a request from a second UE (e.g., UE-B) for wireless resources to be used for communication between the first UE and the second UE. Wireless resources, for instance, represent frequency resources, time resources, slots, and so forth. Further, the request can be communicated via a MAC-CE and an SCI. However, in some scenarios, information of the request included in the SCI may be successfully received but information in the MAC-CE is not successfully received, e.g., the MAC-CE cannot be decoded. Further, situations may occur where the first UE transmits a response to the second UE with inter-UE coordination information (e.g., describing preferred and/or non-preferred resources) using a MAC-CE and SCI, and the MAC-CE is not successfully received, e.g., cannot be decoded. Thus, error conditions may occur due to the inability of some wireless systems to account for scenarios where portions of requests for inter-UE coordination are not successfully received, and/or wherein portions of inter-UE coordination information are not successfully received. Accordingly, techniques for messaging for inter-UE coordination described herein provide ways for mitigating and/or preventing such error conditions and thus increase the reliability of inter-UE communications and connectivity.

Aspects of the present disclosure are described in the context of a wireless communications system. Aspects of the present disclosure are further illustrated and described with reference to device diagrams and flowcharts that relate to messaging for inter-UE coordination.

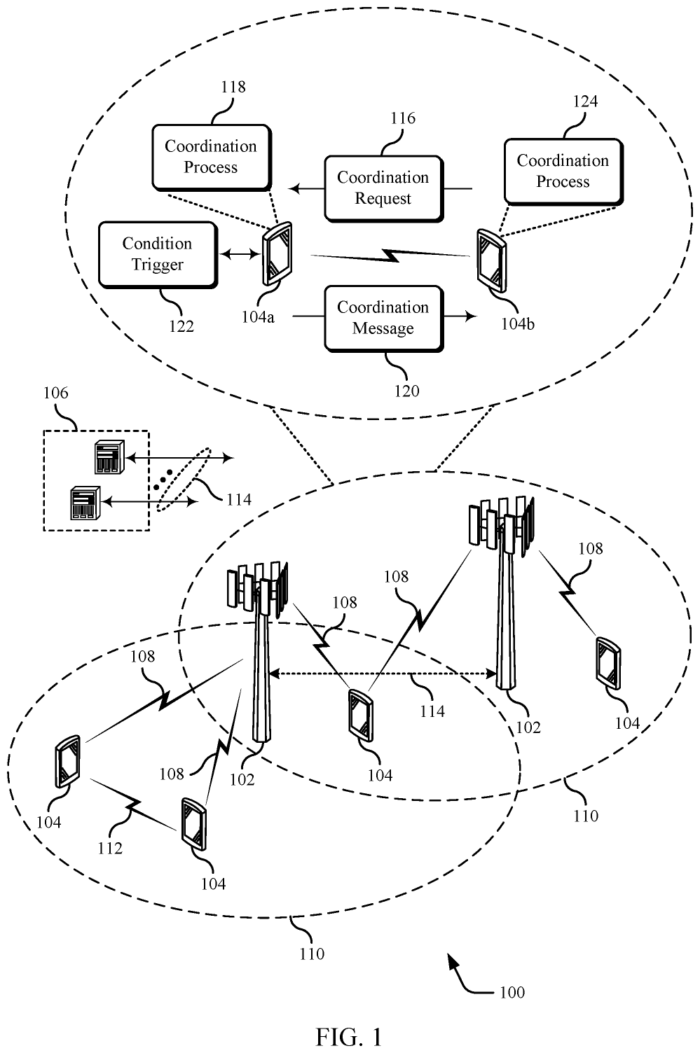

FIG. 1 illustrates an example of a wireless communications system 100 that supports messaging for inter-UE coordination in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, instances of the UEs 104 are operable to implement various aspects of messaging for inter-UE coordination as described herein. For instance, a UE 104a receives a coordination request 116 transmitted by a UE 104b to the UE 104a. The coordination request 116, for example, requests inter-UE coordination information from the UE 104a, such as resources for communication between the UE 104b and the UE 104a. In some scenarios portions of the coordination request 116 may not be successfully received, such as where a MAC-CE that carries portions of the coordination request 116 cannot be successfully decoded. In such scenarios the UE 104a can implement a coordination process 118 to determine one or more operations to be performed and/or not performed based on a failure to successfully receive and/or decode portions of the coordination request 116. The coordination process 118, for instance, specifies whether and/or how the UE 104a responds to the UE 104b with inter-UE coordination information. Example attributes of the coordination process 118 are detailed throughout this disclosure.

In some implementations the UE 104a generates a coordination message 120 in response to the coordination request 116. The coordination message 120, for instance, includes inter-UE coordination information such as identifiers for preferred and/or non-preferred resources for communicating with the UE 104a. Additionally or alternatively to communicating the coordination message 120 based on the coordination request 116, the UE 104a can communicate the coordination message 120 in response to a condition trigger 122. The condition trigger 122, for instance, represents a condition detected at the UE 104a that causes the UE 104a to initiate transmission of inter-UE coordination information to the UE 104b. Accordingly, the UE 104a transmits the coordination message 120 to the UE 104b to notify the UE 104b of inter-UE coordination information, such as preferred and/or non-preferred resources for communicating with the UE 104a.

In some scenarios portions of the coordination message 120 may not be successfully received, such as where a MAC-CE that carries portions of the coordination message 120 cannot be successfully decoded. In such scenarios the UE 104b can implement a coordination process 124 to determine one or more operations to be performed and/or not performed based on a failure to successfully receive and/or decode portions of the coordination message 120. The coordination process 124, for instance, specifies whether and/or how the UE 104b processes information included in the coordination message 120. Example attributes of the coordination process 124 are detailed throughout this disclosure.

In some wireless systems, schemes of inter-UE coordination (e.g., in Mode 2) are categorized as being based on the following types of “A set of resources” sent by UE-A to UE-B:
UE-A sends to UE-B the set of resources preferred for UE-B's transmission
   e.g., based on its sensing result
UE-A sends to UE-B the set of resources not preferred for UE-B's transmission
   e.g., based on its sensing result and/or expected/potential resource conflict
UE-A sends to UE-B the set of resource where the resource conflict can be detected

Further, in some wireless systems, for schemes of inter-UE coordination, at least the following aspects are further discussed:
How/when UE-A determines the contents of “A set of resources”, including consideration of UL scheduling
When UE-A sends “A set of resources” to UE-B, including which UE(s) sends it
How UE-A and UE-B are determined
How UE-A sends “A set of resources” to UE-B, including container used for carrying it, implicitly or explicitly or both
How/when/whether UE-B receives “A set of resources” and takes it into account in the resource selection for its own transmission
How/whether to define the relationship between support/signaling of inter-UE coordination and cast type

Further, some wireless systems would benefit from support for the following schemes of inter-UE coordination (e.g., in Mode 2):
Inter-UE Coordination Scheme 1:
   The coordination information sent from UE-A to UE-B is the set of resources preferred and/or non-preferred for UE-B's transmission
      Down-selection between a preferred resource set and a non-preferred resource set, whether to include any additional information other than indicating time/frequency of the resources within the set in the coordination information.

For inter-UE coordination information transmission (e.g., in Scheme 1):
Inter-UE coordination information can be multiplexed with other data if the source/destination ID pair can be the same
   Retransmission of the TB carrying inter-UE coordination information can be supported
For explicit request transmission (e.g., in Scheme 1):
   Explicit request can be multiplexed with other data if the source/destination ID pair can be the same
   Retransmission of the TB carrying request can be supported
UE implementation can determine whether to use the preferred resource set from SCI format 2-C and/or MAC CE
UE implementation can determine whether to use the preferred resource set from SCI format 2-C and/or MAC CE

For inter-UE coordination information transmission (e.g., in Scheme 1), MAC CE or 2nd SCI can be used as a container of inter-UE coordination information transmission from UE-A to UE-B. Resources, for instance, can be indicated via a time resource indicator value (TRIV) and a frequency resource indicator value (FRIV). For the indication of a resource set, the following can be supported:
For N combinations of TRIV, FRIV, resource reservation period with following modification. The value of resource reservation period can be omitted at least when the transmission of preferred resource set can be triggered by UE-B's explicit request.
   First resource location of each TRIV can be separately indicated by the inter-UE coordination information
If N<=2, MAC CE can be used and UE implementation can determine to additionally use 2nd SCI. When 2nd SCI and MAC CE are both used, the same resource set can be indicated in the 2nd SCI and the MAC CE. If N>2, MAC CE individually can be used.
   The field size of the indication of resource set in a SCI format 2-C can be determined by N=2

Thus, in some wireless systems, different coordination schemes can be provided for inter-UE coordination as part of UE-to-UE wireless communication. For instance, in some scenarios a first UE (e.g. UE-A) receives a request from a second UE (e.g., UE-B) for wireless resources to be used for communication between the first UE and the second UE. Wireless resources, for instance, represent frequency resources, time resources, slots, and so forth. Further, the request can be communicated via a MAC-CE and an SCI. However, in some scenarios, information of the request included in the SCI may be successfully received but information in the MAC-CE is not successfully received, e.g., the MAC-CE cannot be decoded. Further, situations may occur where the first UE transmits a response to the second UE with inter-UE coordination information (e.g., describing preferred and/or non-preferred resources) using a MAC-CE and SCI, and the MAC-CE is not successfully received, e.g., cannot be decoded. Thus, error conditions may occur due to the inability of some wireless systems to account for scenarios where portions of requests for inter-UE coordination are not successfully received, and/or wherein portions of inter-UE coordination information are not successfully received.

Thus, to mitigate these deficiencies in some wireless systems, implementations for messaging for inter-UE coordination provide ways for handling scenarios for inter-UE coordination where a request (e.g., an explicit request) for inter-UE coordination information is transmitted via a MAC-CE and SCI and portions of the request in the MAC-CE are unable to be decoded. Further, the described techniques provide ways for handling scenarios for inter-UE coordination where inter-UE coordination information is transmitted via a MAC-CE and SCI and portions of the inter-UE coordination information in the MAC-CE are unable to be decoded. Implementations also provide for priority-based handling of requests for inter-UE coordination information. By utilizing the described techniques, errors that occur as part of negotiating UE-to-UE communication (e.g., sidelink communications) can be mitigated.

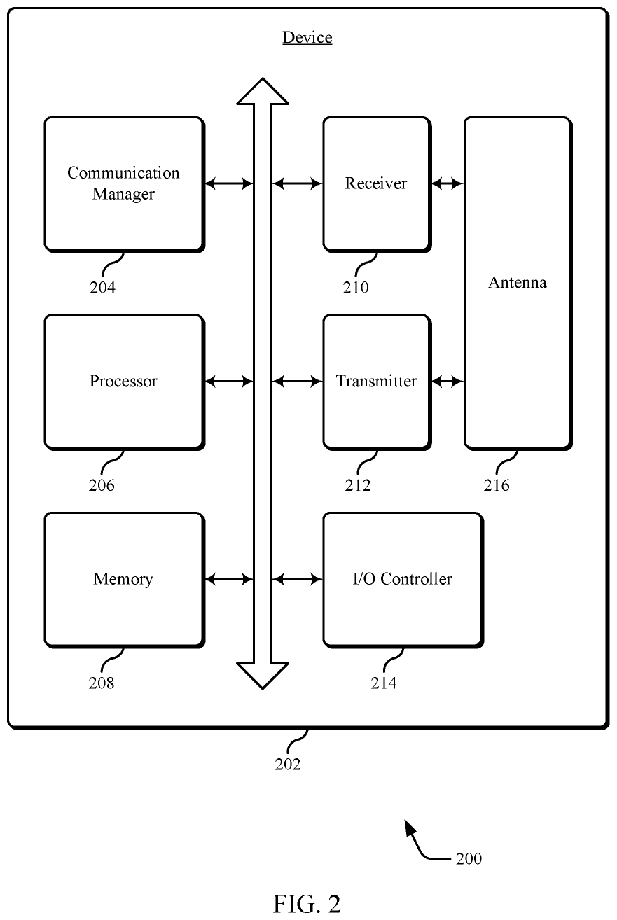

FIG. 2 illustrates an example of a block diagram 200 of a device 202 that supports messaging for inter-UE coordination in accordance with aspects of the present disclosure. The device 202 may be an example of a UE 104 as described herein. The device 202 may support wireless communication and/or network signaling with one or more base stations 102, other UEs 104, network entities and devices, or any combination thereof. The device 202 may include components for bi-directional communications including components for transmitting and receiving communications, such as a communications manager 204, a processor 206, a memory 208, a receiver 210, a transmitter 212, and an I/O controller 214. These components may be in electronic communication or otherwise coupled (e.g., operatively, communicatively, functionally, electronically, electrically) via one or more interfaces (e.g., buses).

The communications manager 204, the receiver 210, the transmitter 212, or various combinations thereof or various components thereof may be examples of means for performing various aspects of the present disclosure as described herein. For example, the communications manager 204, the receiver 210, the transmitter 212, or various combinations or components thereof may support a method for performing one or more of the functions described herein.

In some implementations, the communications manager 204, the receiver 210, the transmitter 212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 206 and the memory 208 coupled with the processor 206 may be configured to perform one or more of the functions described herein (e.g., by executing, by the processor 206, instructions stored in the memory 208).

Additionally or alternatively, in some implementations, the communications manager 204, the receiver 210, the transmitter 212, or various combinations or components thereof may be implemented in code (e.g., as communications management software or firmware) executed by the processor 206. If implemented in code executed by the processor 206, the functions of the communications manager 204, the receiver 210, the transmitter 212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 204 may be configured to perform various operations (e.g., receiving, monitoring, transmitting) using or otherwise in cooperation with the receiver 210, the transmitter 212, or both. For example, the communications manager 204 may receive information from the receiver 210, send information to the transmitter 212, or be integrated in combination with the receiver 210, the transmitter 212, or both to receive information, transmit information, or perform various other operations as described herein. Although the communications manager 204 is illustrated as a separate component, in some implementations, one or more functions described with reference to the communications manager 204 may be supported by or performed by the processor 206, the memory 208, or any combination thereof. For example, the memory 208 may store code, which may include instructions executable by the processor 206 to cause the device 202 to perform various aspects of the present disclosure as described herein, or the processor 206 and the memory 208 may be otherwise configured to perform or support such operations. For example, the communications manager 204 may support wireless communication and/or network signaling at a device (e.g., the device 202, a UE) in accordance with examples as disclosed herein.

The communications manager 204 and/or other device components may be configured as or otherwise support an apparatus, such as a UE, including a transceiver; a processor coupled to the transceiver, the processor and the transceiver configured to cause the apparatus to: receive, from a second UE, one or more sidelink messages including a request for inter-coordination between the first UE and the second UE, the one or more sidelink messages including one or both of a sidelink control message or a sidelink data message, the sidelink control message including SCI and the sidelink data message including a MAC-CE; process the request based on a determination of whether the sidelink data message can be decoded; and transmit, to the second UE, a HARQ feedback message indicating a status of the decoding of the sidelink data message.

Additionally, the apparatus (e.g., a UE) includes any one or combination of: where the processor and the transceiver are configured to cause the first UE to transmit inter-UE coordination information to the second UE based on a priority indication for the inter-UE coordination information; determine not to transmit inter-UE coordination information based on a determination that the sidelink data message cannot be decoded; and transmit a negative acknowledgement message to the second UE, the negative acknowledgement message including a request for retransmission, to the first UE, of the sidelink data message multiplexed with other data; determine that the sidelink data message cannot be decoded; transmit, based on the request, inter-UE coordination information to the second UE; and transmit a negative acknowledgement message to the second UE, the negative acknowledgement message including a request for retransmission, to the first UE, of the sidelink data message multiplexed with other data; determine that the sidelink data message cannot be decoded; transmit, based on successfully receiving the sidelink control message with the request, inter-UE coordination information to the second UE; and transmit an acknowledgement message to the second UE, the acknowledgement message acknowledging receipt and processing of the request.

Additionally, the apparatus (e.g., a UE) includes any one or combination of: determine not to transmit inter-UE coordination information based on the determination that the sidelink data message cannot be decoded; and transmit a negative acknowledgement message to the second UE, the negative acknowledgement message including a request for retransmission, to the first UE, of the sidelink data message not multiplexed with other data; generate an inter-UE coordination message that includes inter-UE coordination information; and determine whether to transmit the inter-UE coordination message based on whether the sidelink data message is successfully decoded; initiate a timer based on receiving the request; and determine whether to transmit the inter-UE coordination message based on whether the sidelink data message is successfully decoded prior to expiry of the timer; initiate a timer based on receiving the request; determine that the sidelink data message is successfully decoded after expiry of the timer; and generate the inter-UE coordination message based on a priority value for the request being above a threshold priority value; where the processor and the transceiver are configured to cause the first UE to ignore the request based on a determination that information in the sidelink control message does not match information in the sidelink data message; determine that a resource set type field of the request is indicated as a preferred resource set; and generate and transmit inter-UE coordination information to the second UE irrespective of the status of the decoding of the sidelink data message. The resource set type field, for instance, can be configured and/or preconfigured in a resource pool, such as for a preferred and/or non-preferred resource type.

According to at least some implementations, operations and/or behaviors of the apparatus (such as described above) may be configured and/or preconfigured in a resource pool. Further, performance of the operations and/or behaviors can be based on a priority value in a request for inter-coordination and/or a packet delay budget (PDB) (e.g., latency of a packet) of data to be transmitted. For instance, a threshold priority value can be defined, and the described operations and/or behaviors can be performed or not performed based on whether a priority value is above or below the threshold priority value. Additionally or alternatively a threshold PDB can be defined, and the described operations and/or behaviors can be performed or not performed based on whether a PDB value is above or below the threshold PDB.

The communications manager 204 and/or other device components may be configured as or otherwise support a means for wireless communication and/or network signaling at a UE, including receiving, at a first user equipment (UE) from a second UE, one or more sidelink messages including a request for inter-coordination between the first UE and the second UE, the one or more sidelink messages including one or both of a sidelink control message or a sidelink data message, the sidelink control message including SCI and the sidelink data message including a MAC-CE; processing the request based on a determination of whether the sidelink data message can be decoded; and transmitting, to the second UE, a HARQ feedback message indicating a status of the decoding of the sidelink data message.

Additionally, wireless communication and/or network signaling at the UE includes any one or combination of: further including transmitting inter-UE coordination information to the second UE based on a priority indication for the inter-UE coordination information; further including: determining not to transmit inter-UE coordination information based on a determination that the sidelink data message cannot be decoded; and transmitting a negative acknowledgement message to the second UE, the negative acknowledgement message including a request for retransmission, to the first UE, of the sidelink data message multiplexed with other data; further including: determining that the sidelink data message cannot be decoded; transmitting, based on the request, inter-UE coordination information to the second UE; and transmitting a negative acknowledgement message to the second UE, the negative acknowledgement message including a request for retransmission, to the first UE, of the sidelink data message multiplexed with other data; further including: determining that the sidelink data message cannot be decoded; transmitting, based on successfully receiving the sidelink control message with the request, inter-UE coordination information to the second UE; and transmitting an acknowledgement message to the second UE, the acknowledgement message acknowledging receipt and processing of the request.

Additionally, wireless communication and/or network signaling at the UE includes any one or combination of: further including: determining not to transmit inter-UE coordination information based on the determination that the sidelink data message cannot be decoded; and transmitting a negative acknowledgement message to the second UE, the negative acknowledgement message including a request for retransmission, to the first UE, of the sidelink data message not multiplexed with other data; further including: generating an inter-UE coordination message that includes inter-UE coordination information; and determining whether to transmit the inter-UE coordination message based on whether the sidelink data message is successfully decoded; further including: initiating a timer based on receiving the request; and determining whether to transmit the inter-UE coordination message based on whether the sidelink data message is successfully decoded prior to expiry of the timer; further including: initiating a timer based on receiving the request; determining that the sidelink data message is successfully decoded after expiry of the timer; and generating the inter-UE coordination message based on a priority value for the request being above a threshold priority value; further including ignoring the request based on a determination that information in the sidelink control message does not match information in the sidelink data message; further including: determining that a resource set type field of the request is indicated as a preferred resource set; and generating and transmitting inter-UE coordination information to the second UE irrespective of the status of the decoding of the sidelink data message. The resource set type field, for instance, can be configured and/or preconfigured in a resource pool, such as for a preferred and/or non-preferred resource type.

According to at least some implementations, operations and/or behaviors of the UE (such as described above) may be configured and/or preconfigured in a resource pool. Further, performance of the operations and/or behaviors can be based on a priority value in a request for inter-coordination and/or a PDB (e.g., latency of a packet) of data to be transmitted. For instance, a threshold priority value can be defined, and the described operations and/or behaviors can be performed or not performed based on whether a priority value is above or below the threshold priority value. Additionally or alternatively a threshold PDB can be defined, and the described operations and/or behaviors can be performed or not performed based on whether a PDB value is above or below the threshold PDB.

The communications manager 204 and/or other device components may be configured as or otherwise support an apparatus, such as a UE, including a transceiver; a processor coupled to the transceiver, the processor and the transceiver configured to cause the apparatus to: receive, from a second UE, one or more sidelink messages including a response to a request from the first UE to the second UE for inter-coordination between the first UE and the second UE, the one or more sidelink messages including one or both of a sidelink control message or a sidelink data message, the sidelink control message including SCI and the sidelink data message including a MAC-CE; process the response based on a determination of whether the sidelink data message can be decoded; and transmit, to the second UE, a HARQ feedback message indicating a status of the decoding of the sidelink data message.

Additionally, the apparatus (e.g., a UE) includes any one or combination of: where the processor and the transceiver are configured to cause the first UE to transmit the request from the first UE to the second UE for inter-coordination based on a priority indication for the request; determine not to process inter-UE coordination information received as part of the response based on a determination that the sidelink data message cannot be decoded; and transmit a negative acknowledgement message to the second UE, the negative acknowledgement message including a request for retransmission, to the first UE, of the sidelink data message multiplexed with other data; determine that the sidelink data message cannot be decoded; process, based on successfully receiving the sidelink control message with the response, inter-UE coordination information received as part of the response; and transmit an acknowledgement message to the second UE, the acknowledgement message requesting retransmission, to the first UE, of the sidelink data message multiplexed with other data; determine that the sidelink data message cannot be decoded; process, based on successfully receiving the sidelink control message with the response, inter-UE coordination information received as part of the response; and transmit an acknowledgement message to the second UE, the acknowledgement message acknowledging receipt and processing of the inter-UE coordination information.

Additionally, the apparatus (e.g., a UE) includes any one or combination of: determine that the sidelink data message cannot be decoded; process, based on successfully receiving the sidelink control message with the response, inter-UE coordination information received as part of the response; and transmit a negative acknowledgement message to the second UE, the negative acknowledgement message including a request for retransmission, to the first UE, of the sidelink data message not multiplexed with other data; process, based on successfully receiving the sidelink control message with the response, inter-UE coordination information received as part of the response; perform, based on the inter-UE coordination information, one or more of resource selection, resource reselection, or resource exclusion; and determine, based on whether the sidelink data message is successfully decoded, whether to transmit an indication of a preferred resource set to a higher layer of the first UE; where the processor and the transceiver are configured to cause the first UE to ignore inter-UE coordination information received as part of the response based on a determination that inter-UE coordination information included as part of the sidelink control message does not match inter-UE coordination information included as part of the sidelink data message; determine that a resource set type field of the response is indicated as a non-preferred resource set; and process inter-UE coordination information included in the response irrespective of the status of the decoding of the sidelink data message to cause the non-preferred resource set to be excluded from resource selection. The resource set type field, for instance, can be configured and/or preconfigured in a resource pool, such as for a preferred and/or non-preferred resource type.

According to at least some implementations, operations and/or behaviors of the apparatus (such as described above) may be configured and/or preconfigured in a resource pool. Further, performance of the operations and/or behaviors can be based on a priority value in a request for inter-coordination and/or a PDB (e.g., latency of a packet) of data to be transmitted. For instance, a threshold priority value can be defined, and the described operations and/or behaviors can be performed or not performed based on whether a priority value is above or below the threshold priority value. Additionally or alternatively a threshold PDB can be defined, and the described operations and/or behaviors can be performed or not performed based on whether a PDB value is above or below the threshold PDB.

The communications manager 204 and/or other device components may be configured as or otherwise support a means for wireless communication and/or network signaling at a UE, including receiving, at a first user equipment (UE) from a second UE, one or more sidelink messages including a response to a request from the first UE to the second UE for inter-coordination between the first UE and the second UE, the one or more sidelink messages including one or both of a sidelink control message or a sidelink data message, the sidelink control message including SCI and the sidelink data message including a MAC-CE; processing the response based on a determination of whether the sidelink data message can be decoded; and transmitting, to the second UE, a HARQ feedback message indicating a status of the decoding of the sidelink data message.

Additionally, wireless communication and/or network signaling at the UE includes any one or combination of: further including transmitting the request from the first UE to the second UE for inter-coordination based on a priority indication for the request; further including: determining not to processing inter-UE coordination information received as part of the response based on a determination that the sidelink data message cannot be decoded; and transmitting a negative acknowledgement message to the second UE, the negative acknowledgement message including a request for retransmission, to the first UE, of the sidelink data message multiplexed with other data; further including: determining that the sidelink data message cannot be decoded; processing, based on successfully receiving the sidelink control message with the response, inter-UE coordination information received as part of the response; and transmitting an acknowledgement message to the second UE, the acknowledgement message requesting retransmission, to the first UE, of the sidelink data message multiplexed with other data; further including: determining that the sidelink data message cannot be decoded; processing, based on successfully receiving the sidelink control message with the response, inter-UE coordination information received as part of the response; and transmitting an acknowledgement message to the second UE, the acknowledgement message acknowledging receipt and processing of the inter-UE coordination information.

Additionally, wireless communication and/or network signaling at the UE includes any one or combination of: further including: determining that the sidelink data message cannot be decoded; processing, based on successfully receiving the sidelink control message with the response, inter-UE coordination information received as part of the response; and transmitting a negative acknowledgement message to the second UE, the negative acknowledgement message including a request for retransmission, to the first UE, of the sidelink data message not multiplexed with other data; further including: processing, based on successfully receiving the sidelink control message with the response, inter-UE coordination information received as part of the response; performing, based on the inter-UE coordination information, one or more of resource selection, resource reselection, or resource exclusion; and determining, based on whether the sidelink data message is successfully decoded, whether to transmit an indication of a preferred resource set to a higher layer of the first UE; further including ignoring inter-UE coordination information received as part of the response based on a determination that inter-UE coordination information included as part of the sidelink control message does not match inter-UE coordination information included as part of the sidelink data message; further including: determining that a resource set type field of the response is indicated as a non-preferred resource set; and processing inter-UE coordination information included in the response irrespective of the status of the decoding of the sidelink data message to cause the non-preferred resource set to be excluded from resource selection. The resource set type field, for instance, can be configured and/or preconfigured in a resource pool, such as for a preferred and/or non-preferred resource type.

According to at least some implementations, operations and/or behaviors of the UE (such as described above) may be configured and/or preconfigured in a resource pool. Further, performance of the operations and/or behaviors can be based on a priority value in a request for inter-coordination and/or a PDB (e.g., latency of a packet) of data to be transmitted. For instance, a threshold priority value can be defined, and the described operations and/or behaviors can be performed or not performed based on whether a priority value is above or below the threshold priority value. Additionally or alternatively a threshold PDB can be defined, and the described operations and/or behaviors can be performed or not performed based on whether a PDB value is above or below the threshold PDB.

The communications manager 204 and/or other device components may be configured as or otherwise support an apparatus, such as a UE, including a transceiver; a processor coupled to the transceiver, the processor and the transceiver configured to cause the apparatus to: receive, from a second UE, one or more sidelink messages including a request for inter-UE coordination between the first UE and the second UE, the one or more sidelink messages including one or both of a sidelink control message or a sidelink data message, the sidelink control message including SCI and the sidelink data message including a MAC-CE; process the request based on a determination of whether the sidelink data message can be decoded; generate inter-UE coordination information based at least in part on the processed request; and prioritize transmission of the inter-UE coordination information based on a priority indication for the inter-UE coordination information.

Additionally, the apparatus (e.g., a UE) includes any one or combination of: where the priority indication is based on one or more of a priority value indicated in the request for inter-UE coordination, or a priority value configured in a resource pool (e.g., a pool for condition based triggering) used to generate the inter-UE coordination information; cause the first UE to prioritize transmission of inter-UE coordination information in response to the request for inter-UE coordination over transmission of inter-UE coordination information in response to a condition-based trigger for inter-UE coordination; where the request for inter-UE coordination includes a request for a non-preferred resource set, and cause the first UE to prioritize transmission of inter-UE coordination information in response to the request for the non-preferred resource set over transmission of inter-UE coordination information in response to a condition-based trigger for inter-UE coordination. In at least some implementations the apparatus may prioritize the transmission of inter-UE coordination information received from a request according to a resource set type configured and/or preconfigured in a resource pool over the transmission of inter-UE coordination information from condition-based triggering according to the resource set type configured and/or preconfigured in the resource pool, where the resource set type field may be set to preferred and/or non-preferred resource set;

Additionally, the apparatus (e.g., a UE) includes any one or combination of: where the request for inter-UE coordination includes a request for a preferred resource set, and cause the first UE to prioritize transmission of inter-UE coordination information in response to a condition-based trigger for a non-preferred resource set over the request for the preferred resource set; where the request for inter-UE coordination includes a request for a non-preferred resource set, and cause the first UE to prioritize the request for the non-preferred resource set over transmission of inter-UE coordination information in response to a condition-based trigger; where to prioritize transmission of the inter-UE coordination information based on the priority indication, the processor and the transceiver configured to cause the first UE to compare a priority of transmitting in a slot a request to a third UE for inter-UE coordination to a priority of transmission in the slot of the inter-UE coordination information to the second UE; where to prioritize transmission of the inter-UE coordination information based on the priority indication, the processor and the transceiver are configured to cause the first UE to compare a priority of transmitting in a slot a request to a third UE for inter-UE coordination to a priority of receiving in the slot inter-UE coordination information from the second UE.

According to at least some implementations, operations and/or behaviors of the apparatus (such as described above) may be configured and/or preconfigured in a resource pool. Further, performance of the operations and/or behaviors can be based on a priority value in a request for inter-coordination and/or a PDB (e.g., latency of a packet) of data to be transmitted. For instance, a threshold priority value can be defined, and the described operations and/or behaviors can be performed or not performed based on whether a priority value is above or below the threshold priority value. Additionally or alternatively a threshold PDB can be defined, and the described operations and/or behaviors can be performed or not performed based on whether a PDB value is above or below the threshold PDB.

The communications manager 204 and/or other device components may be configured as or otherwise support a means for wireless communication and/or network signaling at a UE, including receiving, at a first user equipment (UE) from a second UE, one or more sidelink messages including a request for inter-UE coordination between the first UE and the second UE, the one or more sidelink messages including one or both of a sidelink control message or a sidelink data message, the sidelink control message including SCI and the sidelink data message including a MAC-CE; processing the request based on a determination of whether the sidelink data message can be decoded; generating inter-UE coordination information based at least in part on the processed request; and prioritizing transmission of the inter-UE coordination information based on a priority indication for the inter-UE coordination information.

Additionally, wireless communication and/or network signaling at the UE includes any one or combination of: where the priority indication is based on one or more of a priority value indicated in the request for inter-UE coordination, or a priority value configured in a resource pool used to generating the inter-UE coordination information; further including prioritizing transmission of inter-UE coordination information in response to the request for inter-UE coordination over transmission of inter-UE coordination information in response to a condition-based trigger for inter-UE coordination; where the request for inter-UE coordination includes a request for a non-preferred resource set, and where the method further includes causing the first UE to prioritize transmission of inter-UE coordination information in response to the request for the non-preferred resource set over transmission of inter-UE coordination information in response to a condition-based trigger for inter-UE coordination; where the request for inter-UE coordination includes a request for a preferred resource set, and where the method further includes causing the first UE to prioritize transmission of inter-UE coordination information in response to a condition-based trigger for a non-preferred resource set over the request for the preferred resource set; wherein prioritizing transmission of the inter-UE coordination information based on the priority indication comprises comparing a priority of transmitting in a slot a request to a third UE for inter-UE coordination to a priority of transmission in the slot of the inter-UE coordination information to the second UE; wherein prioritizing transmission of the inter-UE coordination information based on the priority indication comprises comparing a priority of transmitting in a slot a request to a third UE for inter-UE coordination to a priority of receiving in the slot inter-UE coordination information from the second UE.

According to at least some implementations, operations and/or behaviors of the UE (such as described above) may be configured and/or preconfigured in a resource pool. Further, performance of the operations and/or behaviors can be based on a priority value in a request for inter-coordination and/or a PDB (e.g., latency of a packet) of data to be transmitted. For instance, a threshold priority value can be defined, and the described operations and/or behaviors can be performed or not performed based on whether a priority value is above or below the threshold priority value. Additionally or alternatively a threshold PDB can be defined, and the described operations and/or behaviors can be performed or not performed based on whether a PDB value is above or below the threshold PDB.

The processor 206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 206 may be configured to operate a memory array using a memory controller. In some other implementations, a memory controller may be integrated into the processor 206. The processor 206 may be configured to execute computer-readable instructions stored in a memory (e.g., the memory 208) to cause the device 202 to perform various functions of the present disclosure.

The memory 208 may include random access memory (RAM) and read-only memory (ROM). The memory 208 may store computer-readable, computer-executable code including instructions that, when executed by the processor 206 cause the device 202 to perform various functions described herein. The code may be stored in a non-transitory computer-readable medium such as system memory or another type of memory. In some implementations, the code may not be directly executable by the processor 206 but may cause a computer (e.g., when compiled and executed) to perform functions described herein. In some implementations, the memory 208 may include, among other things, a basic I/O system (BIOS) which may control basic hardware or software operation such as the interaction with peripheral components or devices.

The I/O controller 214 may manage input and output signals for the device 202. The I/O controller 214 may also manage peripherals not integrated into the device 202. In some implementations, the I/O controller 214 may represent a physical connection or port to an external peripheral. In some implementations, the I/O controller 214 may utilize an operating system such as iOS®, ANDROID®, MS-DOS®, MS-WINDOWS®, OS/2®, UNIX®, LINUX®, or another known operating system. In some implementations, the I/O controller 214 may be implemented as part of a processor, such as the processor 206. In some implementations, a user may interact with the device 202 via the I/O controller 214 or via hardware components controlled by the I/O controller 214.

In some implementations, the device 202 may include a single antenna 216. However, in some other implementations, the device 202 may have more than one antenna 216, which may be capable of concurrently transmitting or receiving multiple wireless transmissions. The receiver 210 and the transmitter 212 may communicate bi-directionally, via the one or more antennas 216, wired, or wireless links as described herein. For example, the receiver 210 and the transmitter 212 may represent a wireless transceiver and may communicate bi-directionally with another wireless transceiver. The transceiver may also include a modem to modulate the packets, to provide the modulated packets to one or more antennas 216 for transmission, and to demodulate packets received from the one or more antennas 216.

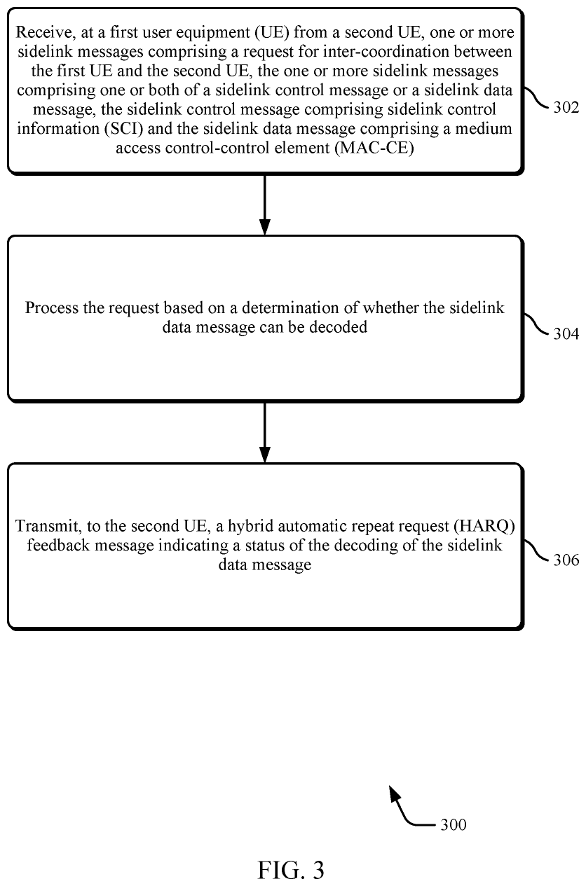

FIG. 3 illustrates a flowchart of a method 300 that supports messaging for inter-UE coordination in accordance with aspects of the present disclosure. The operations of the method 300 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 302, the method may include receiving, at a first user equipment (UE) from a second UE, one or more sidelink messages comprising a request for inter-coordination between the first UE and the second UE, the one or more sidelink messages comprising one or both of a sidelink control message or a sidelink data message, the sidelink control message comprising SCI and the sidelink data message comprising a MAC-CE. The operations of 302 may be performed in accordance with examples as described herein. In some implementations, aspects of the operations of 302 may be performed by a device as described with reference to FIG. 1.

At 304, the method may include processing the request based on a determination of whether the sidelink data message can be decoded. The operations of 304 may be performed in accordance with examples as described herein. In some implementations, aspects of the operations of 304 may be performed by a device as described with reference to FIG. 1.

At 306, the method may include transmitting, to the second UE, a HARQ feedback message indicating a status of the decoding of the sidelink data message. The operations of 306 may be performed in accordance with examples as described herein. In some implementations, aspects of the operations of 306 may be performed by a device as described with reference to FIG. 1.

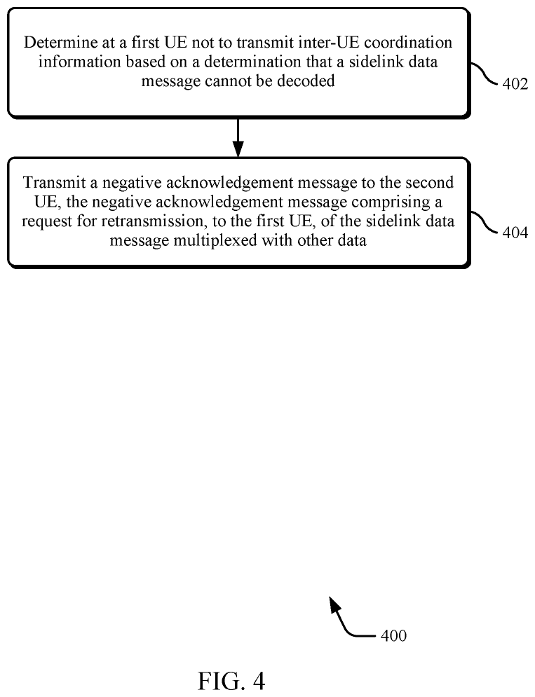

FIG. 4 illustrates a flowchart of a method 400 that supports messaging for inter-UE coordination in accordance with aspects of the present disclosure. The operations of the method 400 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 402, the method may include determining at a first UE not to transmit inter-UE coordination information based on a determination that a sidelink data message cannot be decoded. The operations of 402 may be performed in accordance with examples as described herein. In some implementations, aspects of the operations of 402 may be performed by a device as described with reference to FIG. 1.

At 404, the method may include transmitting a negative acknowledgement message to a second UE, the negative acknowledgement message comprising a request for retransmission, to the first UE, of the sidelink data message multiplexed with other data. The operations of 404 may be performed in accordance with examples as described herein. In some implementations, aspects of the operations of 404 may be performed by a device as described with reference to FIG. 1.

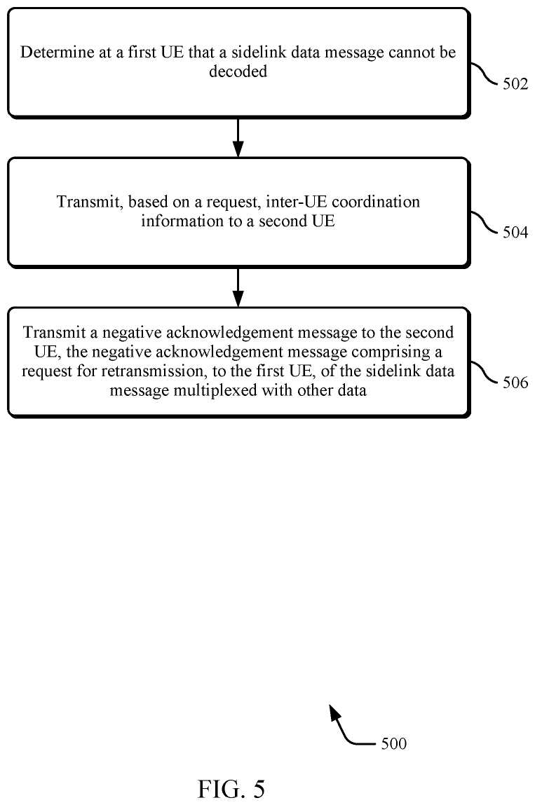

FIG. 5 illustrates a flowchart of a method 500 that supports messaging for inter-UE coordination in accordance with aspects of the present disclosure. The operations of the method 500 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 502, the method may include determining at a first UE that a sidelink data message cannot be decoded. The operations of 502 may be performed in accordance with examples as described herein. In some implementations, aspects of the operations of 502 may be performed by a device as described with reference to FIG. 1.

At 504, the method may include transmitting, based on a request, inter-UE coordination information to a second UE. The operations of 504 may be performed in accordance with examples as described herein. In some implementations, aspects of the operations of 504 may be performed by a device as described with reference to FIG. 1.

At 506, the method may include transmitting a negative acknowledgement message to the second UE, the negative acknowledgement message comprising a request for retransmission, to the first UE, of the sidelink data message multiplexed with other data. The operations of 506 may be performed in accordance with examples as described herein. In some implementations, aspects of the operations of 506 may be performed by a device as described with reference to FIG. 1.

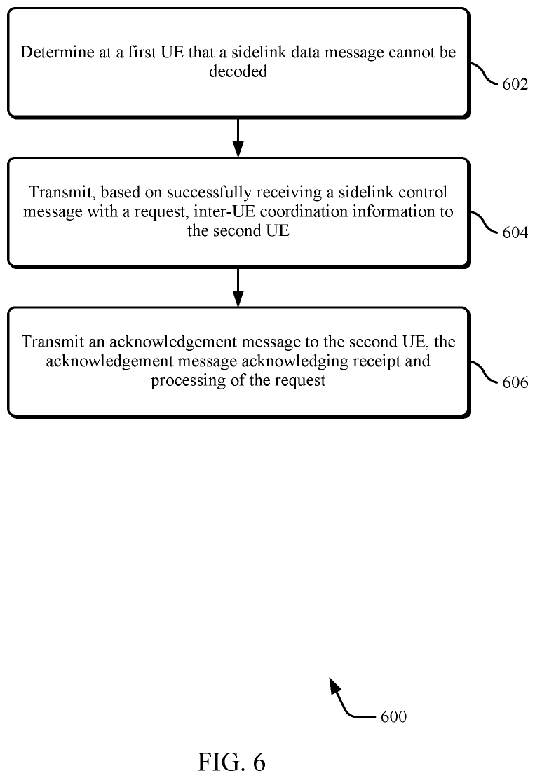

FIG. 6 illustrates a flowchart of a method 600 that supports messaging for inter-UE coordination in accordance with aspects of the present disclosure. The operations of the method 600 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 602, the method may include determining at a first UE that a sidelink data message cannot be decoded. The operations of 602 may be performed in accordance with examples as described herein. In some implementations, aspects of the operations of 602 may be performed by a device as described with reference to FIG. 1.

At 604, the method may include transmitting, based on successfully receiving a sidelink control message with a request, inter-UE coordination information to the second UE. The operations of 604 may be performed in accordance with examples as described herein. In some implementations, aspects of the operations of 604 may be performed by a device as described with reference to FIG. 1.

At 606, the method may include transmitting an acknowledgement message to the second UE, the acknowledgement message acknowledging receipt and processing of the request. The operations of 606 may be performed in accordance with examples as described herein. In some implementations, aspects of the operations of 606 may be performed by a device as described with reference to FIG. 1.

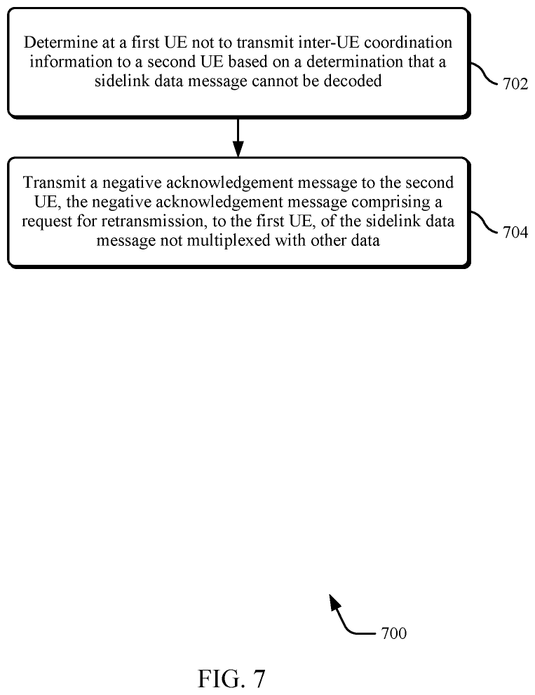

FIG. 7 illustrates a flowchart of a method 700 that supports messaging for inter-UE coordination in accordance with aspects of the present disclosure. The operations of the method 700 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 702, the method may include determining at a first UE not to transmit inter-UE coordination information to a second UE based on a determination that a sidelink data message cannot be decoded. The operations of 702 may be performed in accordance with examples as described herein. In some implementations, aspects of the operations of 702 may be performed by a device as described with reference to FIG. 1.

At 704, the method may include transmitting a negative acknowledgement message to the second UE, the negative acknowledgement message comprising a request for retransmission, to the first UE, of the sidelink data message not multiplexed with other data. The operations of 704 may be performed in accordance with examples as described herein. In some implementations, aspects of the operations of 704 may be performed by a device as described with reference to FIG. 1.

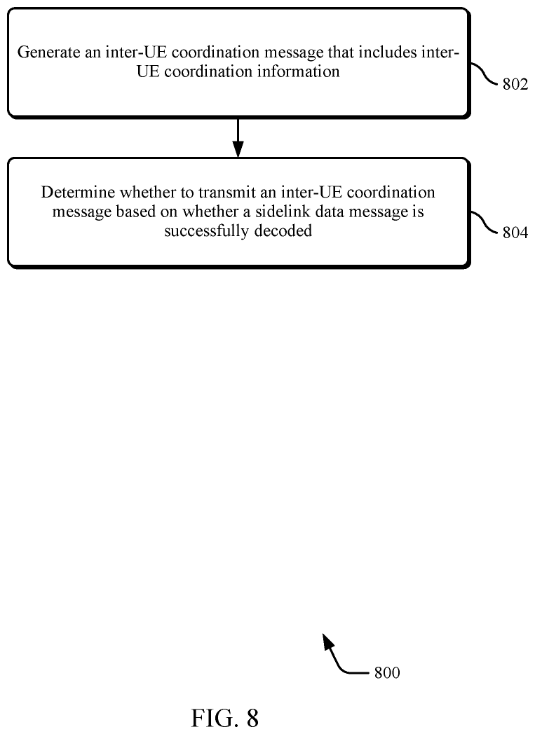

FIG. 8 illustrates a flowchart of a method 800 that supports messaging for inter-UE coordination in accordance with aspects of the present disclosure. The operations of the method 800 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 802, the method may include generating an inter-UE coordination message that includes inter-UE coordination information. The operations of 802 may be performed in accordance with examples as described herein. In some implementations, aspects of the operations of 802 may be performed by a device as described with reference to FIG. 1.

At 804, the method may include determining whether to transmit an inter-UE coordination message based on whether a sidelink data message is successfully decoded. The operations of 804 may be performed in accordance with examples as described herein. In some implementations, aspects of the operations of 804 may be performed by a device as described with reference to FIG. 1.

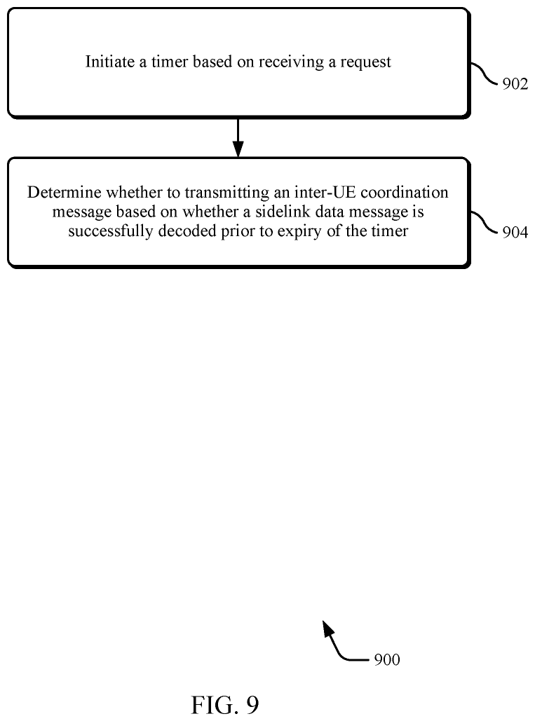

FIG. 9 illustrates a flowchart of a method 900 that supports messaging for inter-UE coordination in accordance with aspects of the present disclosure. The operations of the method 900 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 902, the method may include initiating a timer based on receiving a request. The operations of 902 may be performed in accordance with examples as described herein. In some implementations, aspects of the operations of 902 may be performed by a device as described with reference to FIG. 1.

At 904, the method may include determining whether to transmit an inter-UE coordination message based on whether a sidelink data message is successfully decoded prior to expiry of the timer. The operations of 904 may be performed in accordance with examples as described herein. In some implementations, aspects of the operations of 904 may be performed by a device as described with reference to FIG. 1.

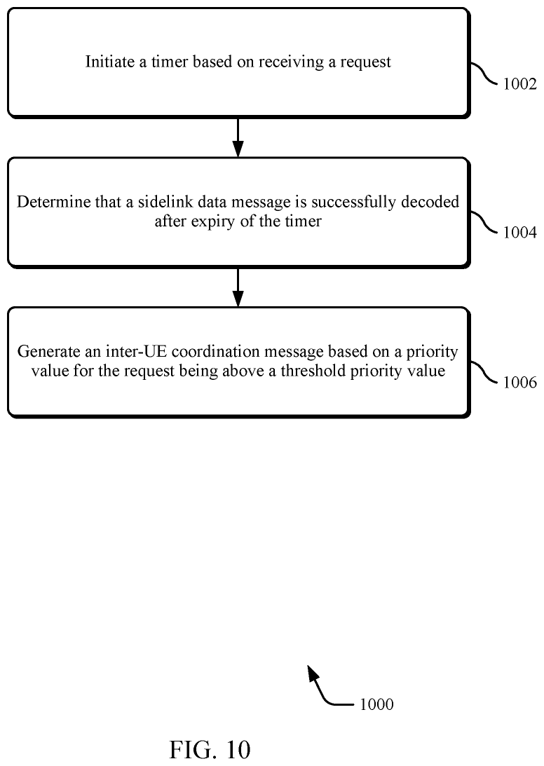

FIG. 10 illustrates a flowchart of a method 1000 that supports messaging for inter-UE coordination in accordance with aspects of the present disclosure. The operations of the method 1000 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1002, the method may include initiating a timer based on receiving a request. The operations of 1002 may be performed in accordance with examples as described herein. In some implementations, aspects of the operations of 1002 may be performed by a device as described with reference to FIG. 1.

At 1004, the method may include determining that a sidelink data message is successfully decoded after expiry of the timer. The operations of 1004 may be performed in accordance with examples as described herein. In some implementations, aspects of the operations of 1004 may be performed by a device as described with reference to FIG. 1.

At 1006, the method may include generating an inter-UE coordination message based on a priority value for the request being above a threshold priority value. The operations of 1006 may be performed in accordance with examples as described herein. In some implementations, aspects of the operations of 1006 may be performed by a device as described with reference to FIG. 1.

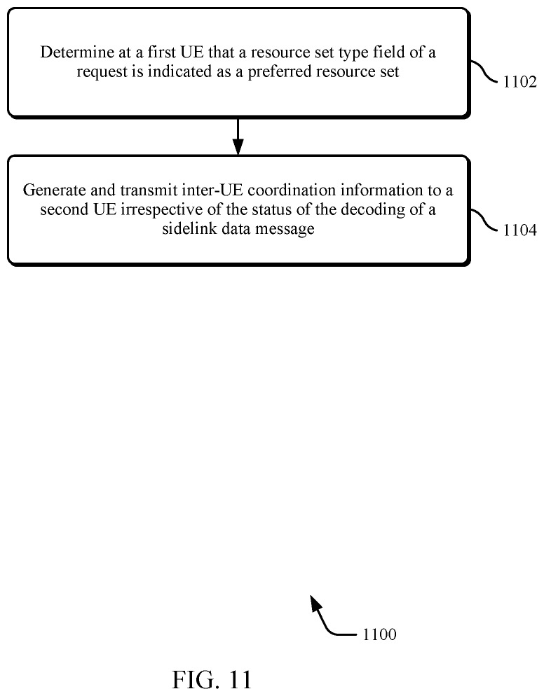

FIG. 11 illustrates a flowchart of a method 1100 that supports messaging for inter-UE coordination in accordance with aspects of the present disclosure. The operations of the method 1100 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1102, the method may include determining at a first UE that a resource set type field of a request is indicated as a preferred resource set. The operations of 1102 may be performed in accordance with examples as described herein. In some implementations, aspects of the operations of 1102 may be performed by a device as described with reference to FIG. 1.

At 1104, the method may include generating and transmitting inter-UE coordination information to a second UE irrespective of the status of the decoding of a sidelink data message. The operations of 1104 may be performed in accordance with examples as described herein. In some implementations, aspects of the operations of 1104 may be performed by a device as described with reference to FIG. 1.

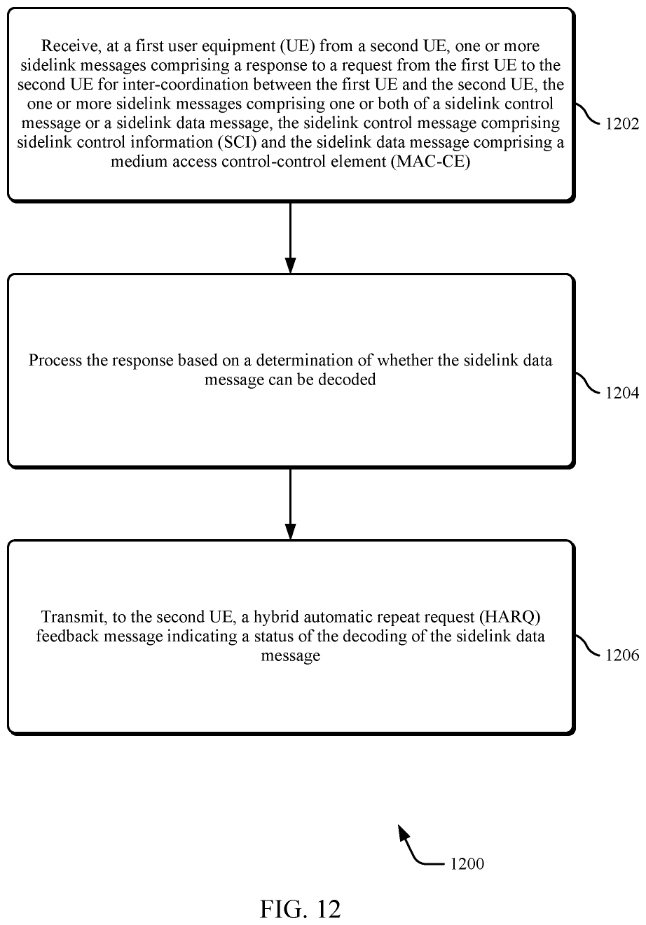

FIG. 12 illustrates a flowchart of a method 1200 that supports messaging for inter-UE coordination in accordance with aspects of the present disclosure. The operations of the method 1200 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1202, the method may include receiving, at a first user equipment (UE) from a second UE, one or more sidelink messages comprising a response to a request from the first UE to the second UE for inter-coordination between the first UE and the second UE, the one or more sidelink messages comprising one or both of a sidelink control message or a sidelink data message, the sidelink control message comprising SCI and the sidelink data message comprising a MAC-CE. The operations of 1202 may be performed in accordance with examples as described herein. In some implementations, aspects of the operations of 1202 may be performed by a device as described with reference to FIG. 1.

At 1204, the method may include processing the response based on a determination of whether the sidelink data message can be decoded. The operations of 1204 may be performed in accordance with examples as described herein. In some implementations, aspects of the operations of 1204 may be performed by a device as described with reference to FIG. 1.

At 1206, the method may include transmitting, to the second UE, a HARQ feedback message indicating a status of the decoding of the sidelink data message. The operations of 1206 may be performed in accordance with examples as described herein. In some implementations, aspects of the operations of 1206 may be performed by a device as described with reference to FIG. 1.

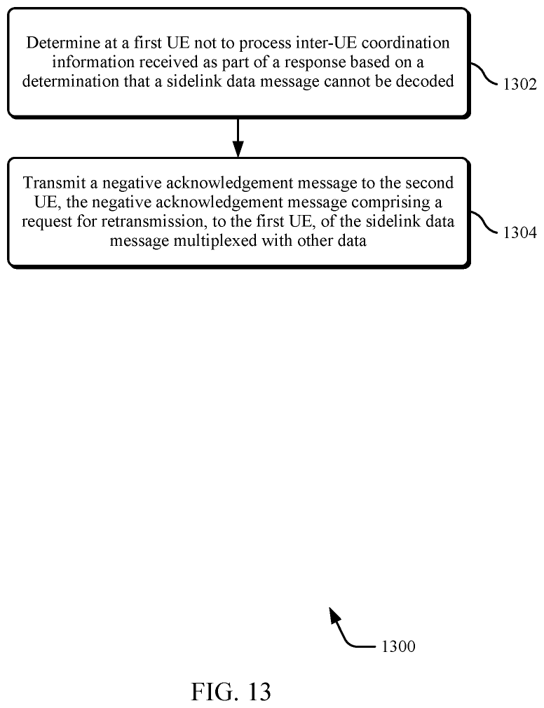

FIG. 13 illustrates a flowchart of a method 1300 that supports messaging for inter-UE coordination in accordance with aspects of the present disclosure. The operations of the method 1300 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1302, the method may include determining at a first UE not to process inter-UE coordination information received as part of a response based on a determination that a sidelink data message cannot be decoded. The operations of 1302 may be performed in accordance with examples as described herein. In some implementations, aspects of the operations of 1302 may be performed by a device as described with reference to FIG. 1.

At 1304, the method may include transmitting a negative acknowledgement message to the second UE, the negative acknowledgement message comprising a request for retransmission, to the first UE, of the sidelink data message multiplexed with other data. The operations of 1304 may be performed in accordance with examples as described herein. In some implementations, aspects of the operations of 1304 may be performed by a device as described with reference to FIG. 1.

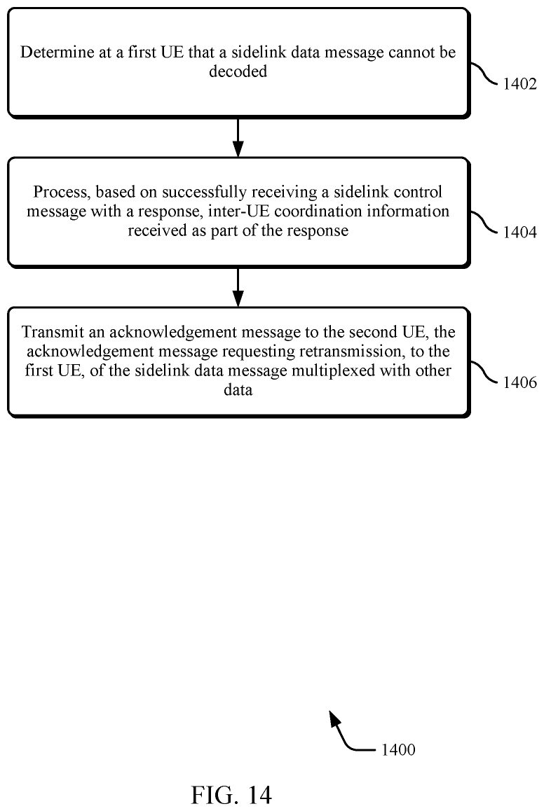

FIG. 14 illustrates a flowchart of a method 1400 that supports messaging for inter-UE coordination in accordance with aspects of the present disclosure. The operations of the method 1400 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1402, the method may include determining at a first UE that a sidelink data message cannot be decoded. The operations of 1402 may be performed in accordance with examples as described herein. In some implementations, aspects of the operations of 1402 may be performed by a device as described with reference to FIG. 1.

At 1404, the method may include processing, based on successfully receiving a sidelink control message with a response, inter-UE coordination information received as part of the response. The operations of 1404 may be performed in accordance with examples as described herein. In some implementations, aspects of the operations of 1404 may be performed by a device as described with reference to FIG. 1.

At 1406, the method may include transmitting an acknowledgement message to the second UE, the acknowledgement message requesting retransmission, to the first UE, of the sidelink data message multiplexed with other data. The operations of 1406 may be performed in accordance with examples as described herein. In some implementations, aspects of the operations of 1406 may be performed by a device as described with reference to FIG. 1.

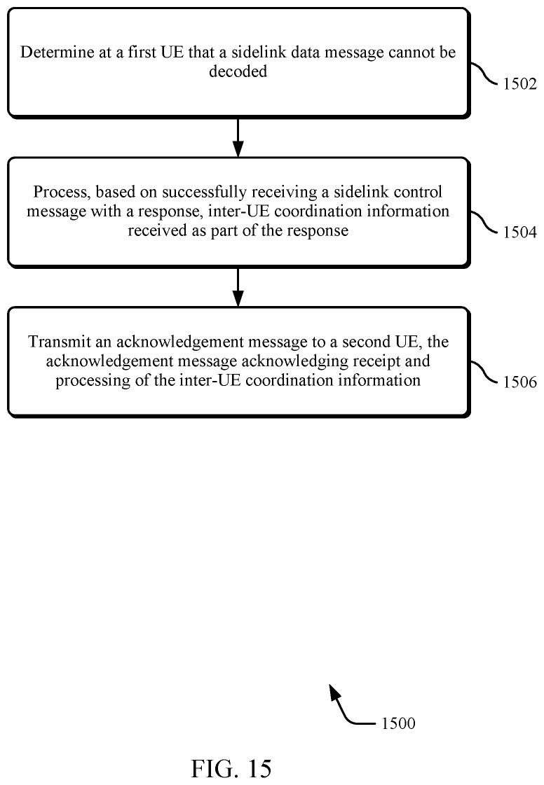

FIG. 15 illustrates a flowchart of a method 1500 that supports messaging for inter-UE coordination in accordance with aspects of the present disclosure. The operations of the method 1500 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1502, the method may include determining at a first UE that a sidelink data message cannot be decoded. The operations of 1502 may be performed in accordance with examples as described herein. In some implementations, aspects of the operations of 1502 may be performed by a device as described with reference to FIG. 1.

At 1504, the method may include processing, based on successfully receiving a sidelink control message with a response, inter-UE coordination information received as part of the response. The operations of 1504 may be performed in accordance with examples as described herein. In some implementations, aspects of the operations of 1504 may be performed by a device as described with reference to FIG. 1.

At 1506, the method may include transmitting an acknowledgement message to a second UE, the acknowledgement message acknowledging receipt and processing of the inter-UE coordination information. The operations of 1506 may be performed in accordance with examples as described herein. In some implementations, aspects of the operations of 1506 may be performed by a device as described with reference to FIG. 1.

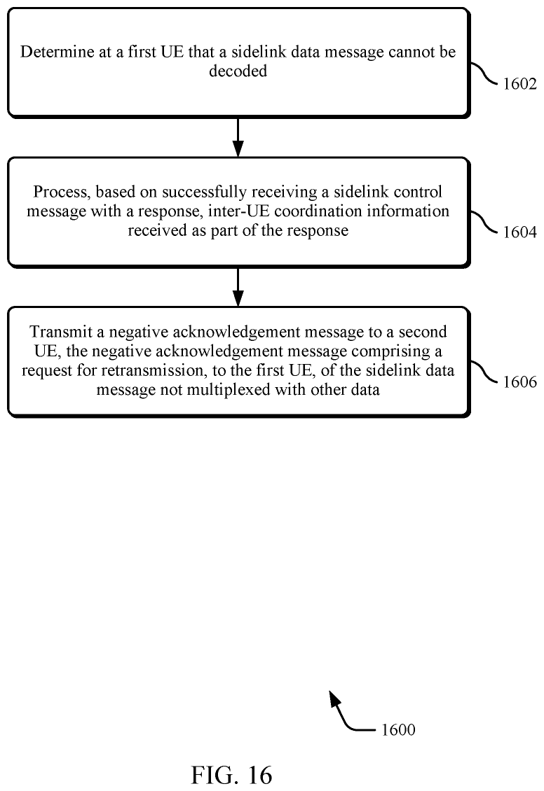

FIG. 16 illustrates a flowchart of a method 1600 that supports messaging for inter-UE coordination in accordance with aspects of the present disclosure. The operations of the method 1600 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1602, the method may include determining at a first UE that a sidelink data message cannot be decoded. The operations of 1602 may be performed in accordance with examples as described herein. In some implementations, aspects of the operations of 1602 may be performed by a device as described with reference to FIG. 1.

At 1604, the method may include processing, based on successfully receiving a sidelink control message with a response, inter-UE coordination information received as part of the response. The operations of 1604 may be performed in accordance with examples as described herein. In some implementations, aspects of the operations of 1604 may be performed by a device as described with reference to FIG. 1.

At 1606, the method may include transmitting a negative acknowledgement message to a second UE, the negative acknowledgement message comprising a request for retransmission, to the first UE, of the sidelink data message not multiplexed with other data. The operations of 1606 may be performed in accordance with examples as described herein. In some implementations, aspects of the operations of 1606 may be performed by a device as described with reference to FIG. 1.

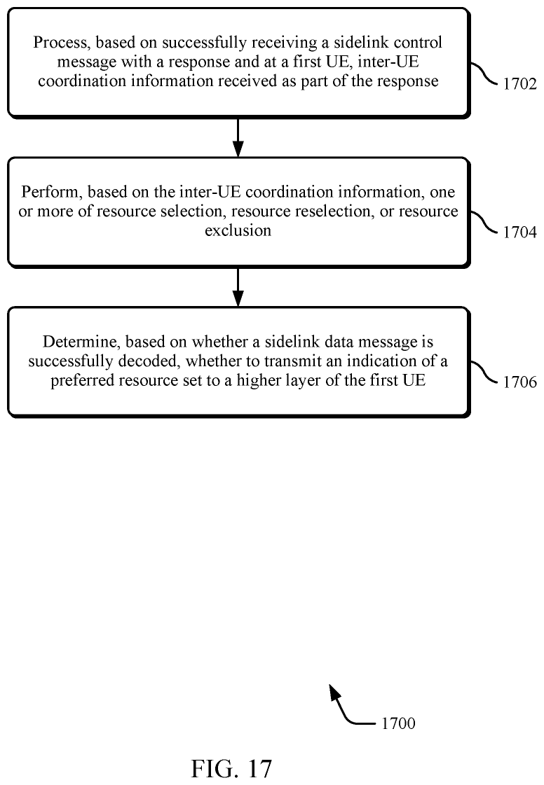

FIG. 17 illustrates a flowchart of a method 1700 that supports messaging for inter-UE coordination in accordance with aspects of the present disclosure. The operations of the method 1700 may be implemented and performed by a device or its components, such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1702, the method may include processing, based on successfully receiving a sidelink control message with a response and at a first UE, inter-UE coordination information received as part of the response. The operations of 1702 may be performed in accordance with examples as described herein. In some implementations, aspects of the operations of 1702 may be performed by a device as described with reference to FIG. 1.

At 1704, the method may include performing, based on the inter-UE coordination information, one or more of resource selection, resource reselection, or resource exclusion. The operations of 1704 may be performed in accordance with examples as described herein. In some implementations, aspects of the operations of 1704 may be performed by a device as described with reference to FIG. 1.

At 1706, the method may include determining, based on whether a sidelink data message is successfully decoded, whether to transmit an indication of a preferred resource set to a higher layer of the first UE. The operations of 1706 may be performed in accordance with examples as described herein. In some implementations, aspects of the operations of 1706 may be performed by a device as described with reference to FIG. 1.

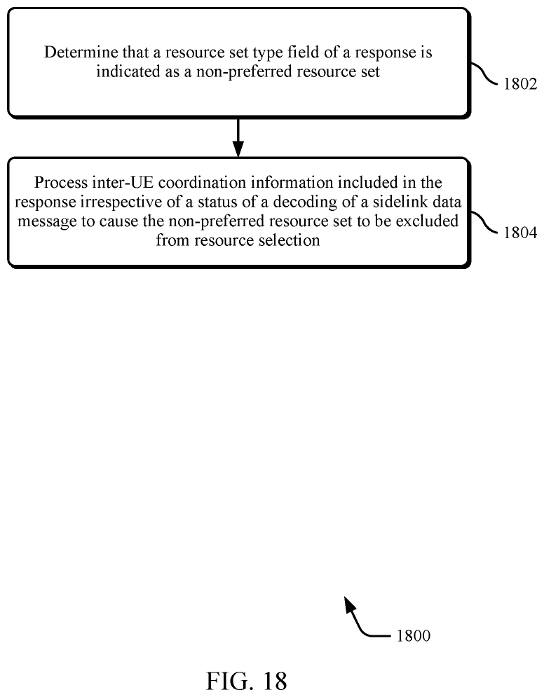

FIG. 18 illustrates a flowchart of a method 1800 that supports messaging for inter-UE coordination in accordance with aspects of the present disclosure. The operations of the method 1800 may be implemented and performed by a device or its components, such as a such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1802, the method may include determining that a resource set type field of a response is indicated as a non-preferred resource set. The operations of 1802 may be performed in accordance with examples as described herein. In some implementations, aspects of the operations of 1802 may be performed by a device as described with reference to FIG. 1.

At 1804, the method may include processing inter-UE coordination information included in the response irrespective of a status of a decoding of a sidelink data message to cause the non-preferred resource set to be excluded from resource selection. The operations of 1804 may be performed in accordance with examples as described herein. In some implementations, aspects of the operations of 1804 may be performed by a device as described with reference to FIG. 1.

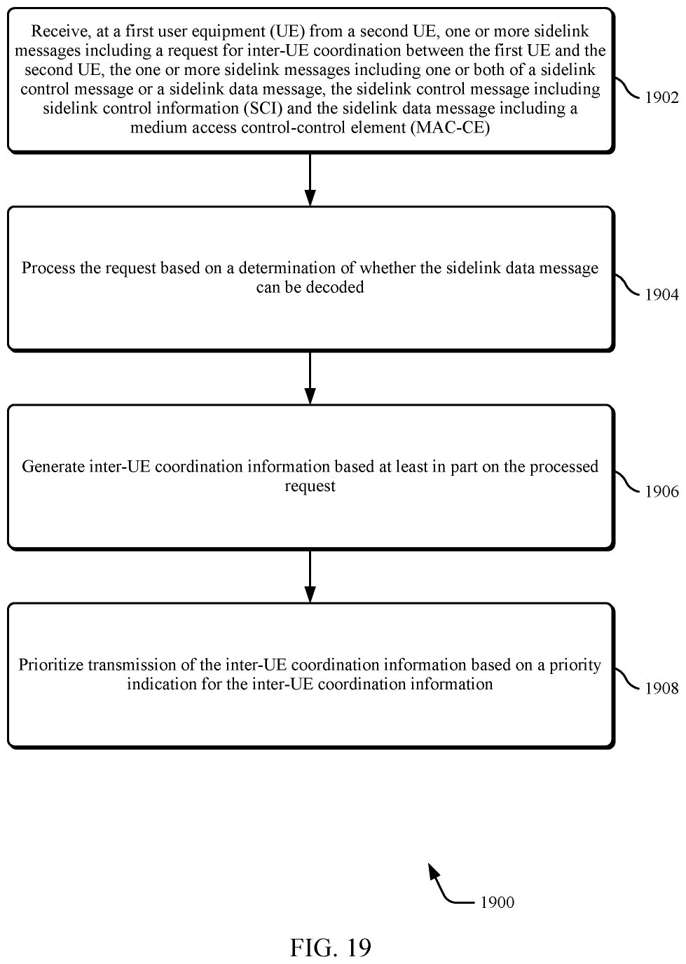

FIG. 19 illustrates a flowchart of a method 1900 that supports messaging for inter-UE coordination in accordance with aspects of the present disclosure. The operations of the method 1900 may be implemented and performed by a device or its components, such as a such as a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 1902, the method may include receiving, at a first user equipment (UE) from a second UE, one or more sidelink messages comprising a request for inter-UE coordination between the first UE and the second UE, the one or more sidelink messages comprising one or both of a sidelink control message or a sidelink data message, the sidelink control message comprising SCI and the sidelink data message comprising a MAC-CE. The operations of 1902 may be performed in accordance with examples as described herein. In some implementations, aspects of the operations of 1902 may be performed by a device as described with reference to FIG. 1.

At 1904, the method may include processing the request based on a determination of whether the sidelink data message can be decoded. The operations of 1904 may be performed in accordance with examples as described herein. In some implementations, aspects of the operations of 1904 may be performed by a device as described with reference to FIG. 1.

At 1906, the method may include generating inter-UE coordination information based at least in part on the processed request. The operations of 1906 may be performed in accordance with examples as described herein. In some implementations, aspects of the operations of 1906 may be performed by a device as described with reference to FIG. 1.

At 1908, the method may include prioritizing transmission of the inter-UE coordination information based on a priority indication for the inter-UE coordination information. The operations of 1908 may be performed in accordance with examples as described herein. In some implementations, aspects of the operations of 1908 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE) comprising:
at least one memory; and
at least one processor coupled with the at least one memory and configured to cause the first UE to:
receive, from a second UE, one or more sidelink messages comprising a request for inter-coordination between the first UE and the second UE, the one or more sidelink messages comprising one or both of a sidelink control message or a sidelink data message, the sidelink control message comprising sidelink control information (SCI) and the sidelink data message comprising a medium access control-control element (MAC-CE);
process the request based on a determination of whether the sidelink data message can be decoded; and
transmit, to the second UE, a hybrid automatic repeat request (HARQ) feedback message indicating a status of the decoding of the sidelink data message.

2. The first UE of claim 1, wherein the at least one processor is configured to cause the first UE to transmit inter-UE coordination information to the second UE based on a priority indication for the inter-UE coordination information.

3. The first UE of claim 1, wherein the at least one processor is configured to cause the first UE to:
determine not to transmit inter-UE coordination information based on a determination that the sidelink data message cannot be decoded; and
transmit a negative acknowledgement message to the second UE, the negative acknowledgement message comprising a request for retransmission, to the first UE, of the sidelink data message multiplexed with other data.

4. The first UE of claim 1, wherein the at least one processor is configured to cause the first UE to:
determine that the sidelink data message cannot be decoded;
transmit, based on the request, inter-UE coordination information to the second UE; and
transmit a negative acknowledgement message to the second UE, the negative acknowledgement message comprising a request for retransmission, to the first UE, of the sidelink data message multiplexed with other data.

5. The first UE of claim 1, wherein the at least one processor is configured to cause the first UE to:
determine that the sidelink data message cannot be decoded;
transmit, based on successfully receiving the sidelink control message with the request, inter-UE coordination information to the second UE; and
transmit an acknowledgement message to the second UE, the acknowledgement message acknowledging receipt and processing of the request.

6. The first UE of claim 1, wherein the at least one processor is configured to cause the first UE to:
determine not to transmit inter-UE coordination information based on the determination that the sidelink data message cannot be decoded; and
transmit a negative acknowledgement message to the second UE, the negative acknowledgement message comprising a request for retransmission, to the first UE, of the sidelink data message not multiplexed with other data.

7. The first UE of claim 1, wherein the at least one processor is configured to cause the first UE to:
generate an inter-UE coordination message that includes inter-UE coordination information; and
determine whether to transmit the inter-UE coordination message based on whether the sidelink data message is successfully decoded.

8. The first UE of claim 7, wherein the at least one processor is configured to cause the first UE to:
initiate a timer based on receiving the request; and
determine whether to transmit the inter-UE coordination message based on whether the sidelink data message is successfully decoded prior to expiry of the timer.

9. The first UE of claim 7, wherein the at least one processor is configured to cause the first UE to:
initiate a timer based on receiving the request;
determine that the sidelink data message is successfully decoded after expiry of the timer; and
generate the inter-UE coordination message based on a priority value for the request being above a threshold priority value.

10. The first UE of claim 1, wherein the at least one processor is configured to cause the first UE to ignore the request based on a determination that information in the sidelink control message does not match information in the sidelink data message.

11. A first user equipment (UE) comprising:
at least one memory; and
at least one processor coupled with the at least one memory and configured to cause the first UE to:
receive, from a second UE, one or more sidelink messages comprising a response to a request from the first UE to the second UE for inter-coordination between the first UE and the second UE, the one or more sidelink messages comprising one or both of a sidelink control message or a sidelink data message, the sidelink control message comprising sidelink control information (SCI) and the sidelink data message comprising a medium access control-control element (MAC-CE);
process the response based on a determination of whether the sidelink data message can be decoded; and
transmit, to the second UE, a hybrid automatic repeat request (HARQ) feedback message indicating a status of the decoding of the sidelink data message.

12. The first UE of claim 11, wherein the at least one processor is configured to cause the first UE to transmit the request from the first UE to the second UE for inter-coordination based on a priority indication for the request.

13. The first UE of claim 11, wherein the at least one processor is configured to cause the first UE to:
determine not to process inter-UE coordination information received as part of the response based on a determination that the sidelink data message cannot be decoded; and
transmit a negative acknowledgement message to the second UE, the negative acknowledgement message comprising a request for retransmission, to the first UE, of the sidelink data message multiplexed with other data.

14. The first UE of claim 11, wherein the at least one processor is configured to cause the first UE to:
determine that the sidelink data message cannot be decoded;
process, based on successfully receiving the sidelink control message with the response, inter-UE coordination information received as part of the response; and
transmit an acknowledgement message to the second UE, the acknowledgement message requesting retransmission, to the first UE, of the sidelink data message multiplexed with other data.

15. The first UE of claim 11, wherein the at least one processor is configured to cause the first UE to:
determine that the sidelink data message cannot be decoded;
process, based on successfully receiving the sidelink control message with the response, inter-UE coordination information received as part of the response; and
transmit an acknowledgement message to the second UE, the acknowledgement message acknowledging receipt and processing of the inter-UE coordination information.

16. The first UE of claim 11, wherein the at least one processor is configured to cause the first UE to:
determine that the sidelink data message cannot be decoded;
process, based on successfully receiving the sidelink control message with the response, inter-UE coordination information received as part of the response; and
transmit a negative acknowledgement message to the second UE, the negative acknowledgement message comprising a request for retransmission, to the first UE, of the sidelink data message not multiplexed with other data.

17. The first UE of claim 11, wherein the at least one processor is configured to cause the first UE to:
process, based on successfully receiving the sidelink control message with the response, inter-UE coordination information received as part of the response;
perform, based on the inter-UE coordination information, one or more of resource selection, resource reselection, or resource exclusion; and
determine, based on whether the sidelink data message is successfully decoded, whether to transmit an indication of a preferred resource set to a higher layer of the first UE.

18. The first UE of claim 11, wherein the at least one processor is configured to cause the first UE to ignore inter-UE coordination information received as part of the response based on a determination that inter-UE coordination information included as part of the sidelink control message does not match inter-UE coordination information included as part of the sidelink data message.

19. (canceled)

20. (canceled)

21. A processor for wireless communication, comprising:
at least one controller coupled with at least one memory and configured to cause the processor to:
receive, at a first user equipment (UE) from a second UE, one or more sidelink messages comprising a request for inter-coordination between the first UE and the second UE, the one or more sidelink messages comprising one or both of a sidelink control message or a sidelink data message, the sidelink control message comprising sidelink control information (SCI) and the sidelink data message comprising a medium access control-control element (MAC-CE);
process the request based on a determination of whether the sidelink data message can be decoded; and
transmit, to the second UE, a hybrid automatic repeat request (HARQ) feedback message indicating a status of the decoding of the sidelink data message.

22. A processor for wireless communication, comprising:
at least one controller coupled with at least one memory and configured to cause the processor to:
receive, at a first user equipment (UE) from a second UE, one or more sidelink messages comprising a response to a request from the first UE to the second UE for inter-coordination between the first UE and the second UE, the one or more sidelink messages comprising one or both of a sidelink control message or a sidelink data message, the sidelink control message comprising sidelink control information (SCI) and the sidelink data message comprising a medium access control-control element (MAC-CE);
process the response based on a determination of whether the sidelink data message can be decoded; and
transmit, to the second UE, a hybrid automatic repeat request (HARQ) feedback message indicating a status of the decoding of the sidelink data message.
